(19) United States
(12) Patent Application Publication
(10) Pub. No.: US 2026/0001160 A1
(43) Pub. Date: Jan. 1, 2026

(54) Friction stir welding device for producing a weld joint

(71) Applicant: ROYOS JOINING SOLUTIONS GMBH, Lieboch (AT)

(72) Inventor: Mario LEITNER, Graz (AT)

(21) Appl. No.: 19/123,180

(22) PCT Filed: Oct. 3, 2023
(86) PCT No.: PCT/AT2023/060344

§ 371 Date: Apr. 22, 2025

(30) Foreign Application Priority Data
Oct. 24, 2022 (AT) A 50821/2022

(51) Int. Cl. B23K 20/12; B23K 103/00; B23K 103/10; B23K 103/18; B29C 65/00; B29C 65/06; B29C 65/64; B29K 677/00

(52) U.S. Cl. CPC B23K 20/1245; B29C 65/0681; B29C 65/645; B29C 66/7422; B23K 2103/10; B23K 2103/18; B23K 2103/42; B29K 2677/00

(57) ABSTRACT

The invention relates to a friction stir welding device for producing a spot-shaped or linear weld joint between a plastic plate or a plastic moulding and a metal or plastic substrate, comprising a welding head and a manually operable or controlled linear feed for the linear movement of the welding head, wherein the welding head comprises a rotatable or oscillatable stirring pin and an outer sleeve surrounding the stirring pin, wherein there is provided a reservoir for receiving material displaced by the stirring pin between the outer sleeve and the stirring pin, wherein the reservoir is limited by a step formed integrally with the outer sleeve or by a reservoir sleeve provided between the outer sleeve and the stirring pin.

The invention relates to a friction stir welding device for producing a spot-shaped or linear weld joint between a plastic plate or a plastic moulding and a metal or plastic substrate, comprising a welding head having a rotatable or oscillatable stirring pin and an outer sleeve surrounding the stirring pin.

According to the prior art, plastic connections (wherein there is herein understood the connection of two plastic components) and plastic-metal connections (wherein there is herein understood a connection between a plastic component and a metal component) are primarily obtained by way of adhesive bonding, conventional welding, screwing, or riveting. Additionally, there is the option of injecting plastics directly through injection moulding; however, this is a complex process and is only conditionally applicable, as the liquid plastic would fill all cavities, such as those, for example, required in a housing. Therefore, a housing cover cannot simply be injected. In the case of screwed and riveted connections, additional seals are required, which may become porous over time or may lead to leaks due to settling or swelling. In this way, water or dirt, for example, may enter or exit.

Furthermore, from prior art there are further known so-called friction stir welding (FSW) methods, in which a rotating stirring pin penetrates into two materials to be connected, remaining rotating within these in order to generate heat. These methods may be conducted as spot welding or linear welding methods, wherein the machines developed for this purpose are preferably designed for the respective welding method and are in general not interchangeably used for both types of welding methods due to specific requirements.

As during friction stir welding of plastics the welding process is exclusively controlled by the penetration and rotation of the tool, this may often lead to the formation of a porous region in or around the weld nugget. Large bubbles may also form, which are caused by thermal shrinkage during the cooling phase.

CN 109967858 A discloses a friction stir welding device for producing a linear weld seam. A stirring pin is guided within a simple outer sleeve that rests on the plastic material to be welded. The outer sleeve is enclosed by a heating device.

CN113020776 also discloses a friction stir welding device for producing a linear weld seam, wherein a stirring pin is integrally formed with the tool head.

DE102014112683A1 reveals a hybrid joining technique, in which both friction and ultrasonic energy are applied onto the workpiece simultaneously. A central horn transmits ultrasonic waves into the workpiece. The horn is surrounded by a ring-shaped friction tool, which is in frictional contact with the tool.

WO 2022/045171 A1 discloses a friction stir welding device for spot welding. In this document, the stirring pin is surrounded by an inner and an outer sleeve. The heat generation for the welding process in this device is carried out solely through friction. The tool is used exclusively for spot welding, and the application for linear welding is therefore far off, as the inner sleeve may also penetrate the material to be welded, which would then prevent linear movement. Similar spot welding methods are disclosed in the documents WO2022045171A1, EP3909714A1, and WO2015145251A1.

KR20070061937A also shows a friction stir welding device for spot welding. Here, two metal layers are to be welded together. As, hence, also the upper layer must be made of metal, longitudinal movement of the device is not possible.

The objective of the invention is to overcome these problems of the prior art and to provide a friction stir welding device for producing a linear or point-shaped weld joint of a plastic plate on a metal or plastic substrate.

This objective is achieved by a friction stir welding device for producing a point-shaped or linear weld joint between a plastic plate or a plastic moulding (hereinafter referred to simply as the plastic plate, although the welding of a plastic moulding is also comprised in the invention) and a metal or plastic substrate, comprising a welding head having a rotatable or oscillatable stirring pin and an outer sleeve surrounding the stirring pin, wherein a reservoir for receiving material displaced by the stirring pin is provided between the outer sleeve and the stirring pin, wherein the reservoir is preferably limited by a step formed integrally with the outer sleeve or by a reservoir sleeve provided between the outer sleeve and the stirring pin (alternatively, the stirring pin could also have a step or the like), wherein the friction stir welding device further comprises a heating device for the direct heating of the stirring pin.

By way of the reservoir according to the invention, it may be ensured for the very first time that an extremely tight weld joint be produced even in a linear welding method. The reservoir prevents the material displaced by the stirring pin (which originates from the plastic plate or the metal or plastic substrate, respectively) from freely swelling outward due to the pressure present in the reservoir, thereby preventing the subsequent inclusion of air.

According to the invention, the pressure during the formation of the weld joint may thus be regulated via the outer sleeve or the reservoir sleeve, thereby further balancing the shrinkage effect, whereas the welding pressure in the prior art is generated exclusively by the pressing force of the tool on the substrate.

In summary, significantly tighter weld joints may therefore be produced than was previously possible in the prior art. In particular, no additional seals are required, which could become porous over time or cause leaks due to settling or swelling.

When a multi-part sleeve system with a reservoir sleeve is used, it may particularly capture excess material, as it may be designed to be movable relative to the outer sleeve. However, the reservoir sleeve cannot be positioned beneath the outer sleeve, such that also cannot penetrate into the plastic plate, as this would not make possible the formation of a linear weld joint. In contrast, an outer sleeve having a step is simpler to manufacture and control. In particular, with this system having an integral outer sleeve with a step, it is easier to provide a through-opening or access point for an electrical connection for heating the stirring pin.

According to the invention, the friction stir welding device further comprises a heating apparatus for the direct heating of the stirring pin. In contrast to the prior art, the process heat does not need to be generated through friction between the tool and the workpiece, as it is provided by the already heated stirring pin. According to the invention, the frictional heat thus serves solely for conditioning, i.e., preheating, the workpiece. The temperature, to which the stirring pin is heated, may be selected in dependence on the materials of the workpiece, the feed rate of the welding head, etc., and may be adjusted as needed via a control unit. In regard to CN 109967858 A, it is to be noted that this document teaches the heating of a shoulder arranged around the welding head, whereby the workpiece is only preconditioned, and the stirring pin is not directly heated, such that the process heat must be generated through the friction of the stirring pin. In contrast, in the present invention, the outer sleeve could even be cooled while the stirring pin is directly heated.

The directly heated stirring pin thus has the advantage that the required process heat does not have to be generated exclusively through friction. According to the invention, hence, new application areas may be opened up, as the process heat, for example, for plastic welding is hardly achievable through friction, given that the coefficient of friction of plastic is very low and the insulating effect of the plastic prevents any “preliminary” heat. Furthermore, because of the directly heated stirring pin there may be used lower rotational speeds, which counteracts shear action within the weld material, thus enabling the material to move better around the pin.

It is to be stressed that the reservoir and the directly heated stirring pin exhibit a synergistic effect, as the material in the reservoir may be maintained at the working temperature.

In order to implement the direct heating of the rotating or oscillating, respectively, stirring pin, the heating apparatus may comprise a heating cartridge arranged within the stirring pin, which is preferably in contact with an energy source located outside the stirring pin via sliding contacts. Alternatively, the heating apparatus could comprise an induction coil arranged around the stirring pin and an inductively heatable material within or on the stirring pin. These two embodiments are particularly preferred to achieve heating of the stirring pin itself even during rotation or oscillation, respectively. In further variants, a heat transfer medium could be passed through the stirring pin, although this would be extremely complex.

Particularly preferably, the friction stir welding device further comprises a manually operable or controlled linear feed for the linear movement of the welding head during the welding process. In practice, it has been found that the friction stir welding device according to the invention is particularly suited for producing tight linear weld joints, for example, to securely attach a lid to a housing.

Furthermore, it is preferred that the welding head, preferably the outer sleeve, comprises a through-opening leading to the reservoir for an external material supply. The through-opening may be particularly used to further regulate the welding pressure by supplying welding additives.

In a further preferred embodiment, the friction stir welding device comprises a coupling that selectively couples the stirring pin with the outer sleeve and/or the reservoir sleeve for the transmission of torque. While it is typically preferred for the outer sleeve to rest on the plastic plate without rotation, there may be provided that the outer sleeve or the reservoir sleeve can rotate to promote the mixing of the material in the reservoir or to follow a predefined contour when using a profiled outer sleeve. According to the invention, the coupling—a so-called stop-lock function—can secure the outer sleeve against rotation. The stirring pin may, depending on the embodiment, also be coupled with one or both of the aforementioned sleeves, allowing them to rotate along with the stirring pin.

It is further preferred that the stirring pin has a section facing the plastic plate, of which at least a part is formed as a conveyor screw. This allows material to be conveyed from the reservoir into the joining zone through rotation. In this embodiment, the outer sleeve preferably has a tapering section facing towards the plastic plate, such that the reservoir does not directly contact the plastic plate. However, in other embodiments, this is not mandatory, meaning that the section with the conveyor screw may also be combined with all other embodiments.

In a further aspect, the invention relates to a friction stir welding method using a friction stir welding device according to one of the aforementioned embodiments, comprising the steps of:
placing the plastic plate onto the metal or plastic substrate,
inserting the stirring pin into the plastic plate until it penetrates the plastic plate and at least contacts the metal or plastic substrate, and positioning the outer sleeve on the plastic plate (wherein this may also be carried out prior to inserting the stirring pin),
moving the welding head via the linear drive with a rotating or oscillating stirring pin while it penetrates the plastic plate and at least contacts the metal or plastic substrate, to produce a linear weld joint. It is further preferred that the stirring pin is heated immediately during this movement.

The friction stir welding method according to the invention has the same advantages as those outlined above for the friction stir welding device. In particular, the welding pressure may be further regulated when welding additives are introduced into the reservoir through the through-opening during the movement of the welding head to create a linear weld joint or to seal the opening.

The welding method is particularly advantageous when the metal or plastic substrate is a housing with an opening and the plastic plate is a lid, wherein the welding method comprises the following steps:
placing the lid onto the opening, and
creating a closed linear weld joint (e.g. a circular or diamond-shaped weld joint) around the opening to securely seal the opening with the lid, meaning that the opening lies within the circular weld joint.

This welding method enables that the opening be particularly tightly closed without the need for additional measures.

The friction stir welding method is especially beneficial when the plastic plate and/or the plastic substrate is made of polyamide, preferably PA6 GF30, and the optionally present metal substrate is made of aluminium, preferably cast aluminium, particularly preferably cast aluminium EN AC44200. It is appreciated that the friction stir welding method according to the invention is not limited to these materials but could also be applied to other materials such as aluminium EN AW6082 for the metal substrate or polycarbonate for the plastic plate or plastic substrate.

These and further advantageous embodiments of the method according to the invention will be explained in greater detail in the following by way of the figures.

FIG. 1 shows a friction stir welding device according to the invention in a schematic side view.

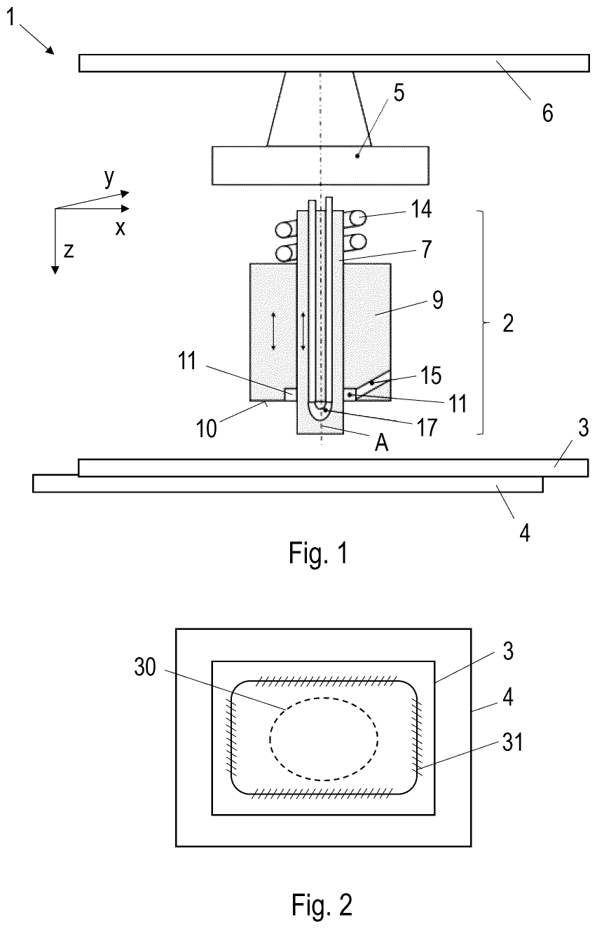

FIG. 2 shows a weld joint produced by the friction stir welding device of FIG. 1 between a lid and a housing.

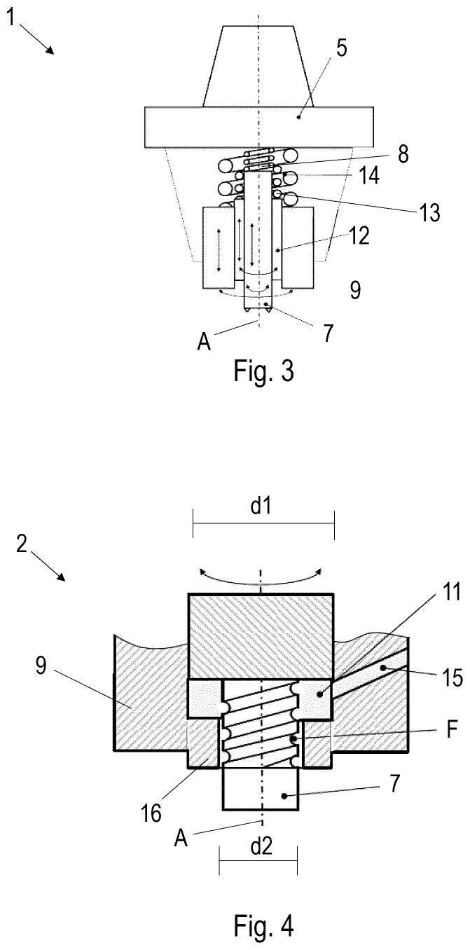

FIG. 3 shows a variant of the friction stir welding device according to the invention with a multi-part sleeve system.

FIG. 4 shows a further variant of the friction stir welding device of FIG. 1 with a stirring pin, whose tip is embodied as a conveyor screw.

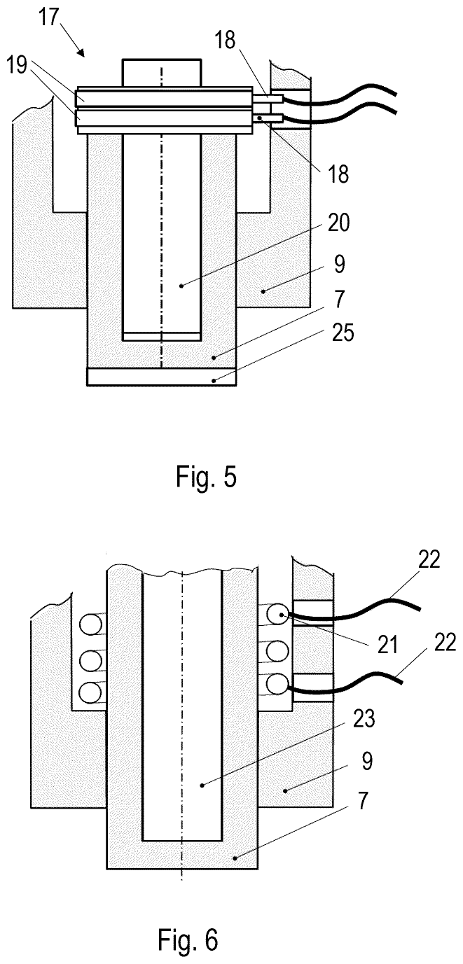

FIG. 5 shows a first embodiment of a heating apparatus for the friction stir welding device according to the invention.

FIG. 6 presents a second embodiment of a heating apparatus for the friction stir welding device according to the invention.

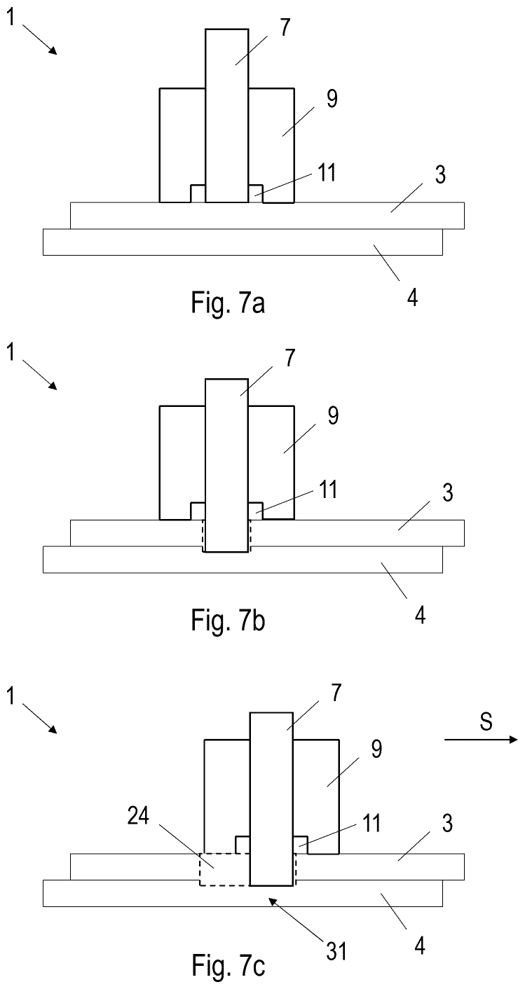

FIGS. 7a-7c show sequential states during the use of the friction stir welding device according to the invention.

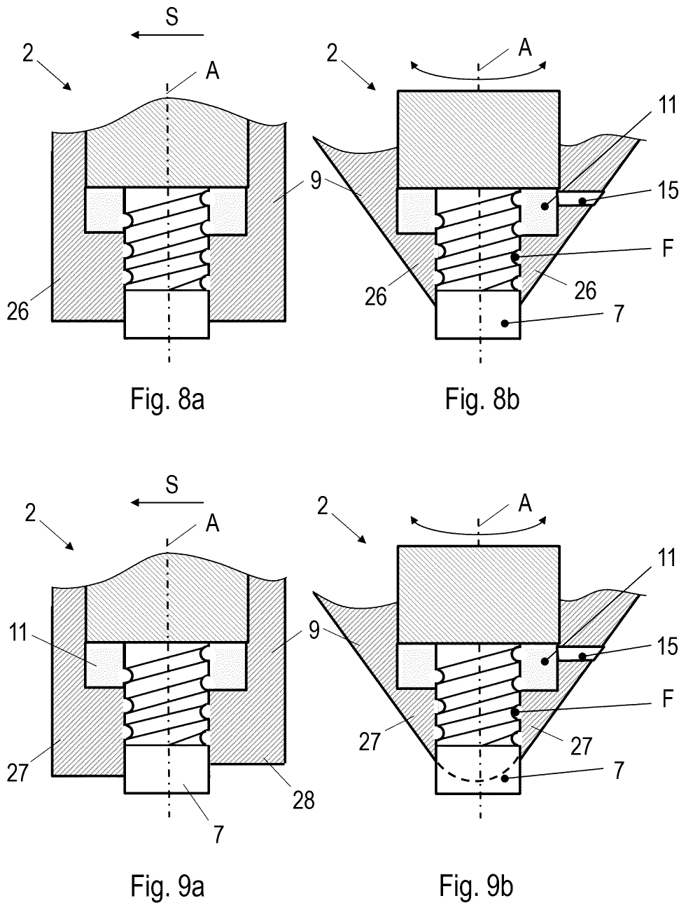

FIGS. 8a and 8b show another variant of the friction stir welding device according to the invention with a profiled outer sleeve in a front view and a side view.

FIGS. 9a and 9b show yet another variant of the friction stir welding device according to the invention with an asymmetrically profiled outer sleeve in a front view and a side view.

FIG. 1 shows a friction stir welding device 1 having a welding head 2. The friction stir welding device 1 is to be used for producing a linear weld joint 31 (FIG. 2), such as an elongated weld seam, between a plastic plate 3 and a metal or plastic substrate 4. The plastic plate 3, however, does not need to be entirely flat, thus it can generally also be referred to as a plastic moulding. The metal or plastic substrate 4 may, for example, be another plate or a solid body. The weld joint 31 produced by the friction stir welding device 1 is to be particularly tight after production, ensuring that the weld joint 31 between the plastic plate 3 and the metal or plastic substrate 4 may find application in fields such as automotive engineering, aerospace technology, or in so-called “white goods”.

In particular, the plastic plate 3 may be as a lid, and the metal or plastic substrate 4 may be a housing, as illustrated in FIG. 2. The housing may have an opening 30, and the lid may be positioned to cover the opening 30. The friction stir welding device 1 is used to create a tight weld joint 31 surrounding the opening 30, thereby tightly sealing the opening 30. In FIG. 2, the weld joint 31 is represented as circular; however, it could also take the form of a diamond shape or similar configurations. Furthermore, the present invention is not limited to this application, and generally, only linear, i.e., non-circumferential, weld joints 31 could be produced. Additionally, the workpiece does not necessarily have to be a combination of a housing and a lid.

In order to obtain a linear advancement of the welding head 2, there may be inserted a not further depicted holding device for the welding head 2 into a tool holder 5 of the friction stir welding device 1, as illustrated in FIG. 1. The tool holder 5 is, for instance, movable along a rail system 6 of the friction stir welding device 1, allowing the welding head 2 to move within a plane defined by the illustrated x-direction and y-direction. This plane is typically parallel to the plastic plate 3 or the metal or plastic substrate 4, respectively. In addition to this linear advancement, the friction stir welding device 1 may further comprise means for lowering and raising the welding head 2 or parts of the welding head 2 in the z-direction, i.e., towards the plastic plate 3 or the metal or plastic substrate 4, respectively.

It is appreciated that the illustrated embodiment of the linear advancement is merely illustrative and could generally be realised differently, for example, through rotational movement. The linear advancement could also be manually operated, for instance, via one or more handwheels, or be automatically controlled, thus enabling the friction stir welding device 1 to function as a CNC machine (Computerized Numerical Control).

In alternative embodiments, the friction stir welding device 1 could also be employed for spot welding, such that linear advancement is not necessarily required. For example, the workpiece could be moved to produce an additional weld point at a different location on the workpiece. In other embodiment variants, the linear drive could be used during spot welding, such that the welding head 2 is automatically or manually transferred to a second location, where another weld point is to be created. The welding head 2 or the stirring pin is raised before moving to the next weld point to avoid creating a linear weld seam.

In order to produce the weld joint 31, the welding head 2 comprises a rotatable or oscillatable stirring pin 7, which may be lowered in the direction of the plastic plate 3 and the metal or plastic substrate 4, herein in the z-direction. This may be achieved, for example, by lowering the tool holder 5, wherein the stirring pin 7 does not need to perform a relative movement with respect to the tool holder 5, as illustrated in FIG. 1, or through a relative movement of the stirring pin 7, which may be initiated by the spring 8 shown by way of example in FIG. 3. The stirring pin 7 may be made of metal or ceramic and may, if necessary, have a coating, in particular a Teflon coating. Additionally, the stirring pin 7 may have a profiling or notch on its outer contour.

In order to ensure that the material displaced by the stirring pin 7 from the plastic plate 3 or the metal or plastic substrate 4, respectively, forms a particularly tight weld joint 31, the welding head 2 further comprises an outer sleeve 9 surrounding the stirring pin 7. The outer sleeve 9 preferably has a flat resting surface 10 facing the plastic plate 3, such that the outer sleeve 9 can move along the plastic plate 3 during a linear advancement while the stirring pin 7 is inserted. In this way, the outer sleeve 9 may seal the area around the stirring pin 7. The outer sleeve 9 may be made of metal or ceramic and may have a coating, if required. It can be designed to be either rotationally symmetrical or profiled to create a fillet weld, for example. See also FIGS. 8a to 9b below.

In order to capture the material displaced during the penetration of the stirring pin 7 into the plastic plate 3 or into the metal or plastic substrate 4, respectively, there is provided a reservoir 11 at the lower end between the outer sleeve 9 and the stirring pin 7. The term “lower end” refers to the end that is facing away from the tool holder 5 or facing the plastic plate 3, respectively.

The reservoir 11 may be configured in various ways according to the invention. As shown in FIG. 1, the outer sleeve 9 may have an extending step at its lower end, which is limited upwards to form the reservoir 11. The step has a corresponding height to capture a predetermined amount of displaced material. The step could also be configured to be tapered, as illustrated in FIG. 4, such that the reservoir 11 is located above the step. In this case, the reservoir 11 could be enclosed by an upwardly expanding stirring pin 7 between the outer sleeve 9 and the stirring pin 7.

As shown in FIG. 3, there may also be used a reservoir sleeve 12 provided between the outer sleeve 9 and the stirring pin 7, which forms a reservoir 11 at the lower end of the welding head 2 by limiting the space determined between the outer sleeve 9 and the stirring pin 7 upwards. In this embodiment, it is possible to provide for a relative movement between the reservoir sleeve 12 and the outer sleeve 9, and preferably also the stirring pin, in order to adjust the height of the reservoir 11, i.e., to set the distance between the resting surface 10 of the outer sleeve 9 and the lower end of the reservoir sleeve 12, which may be realised by the spring 13 illustrated by way of example in FIG. 3. The reservoir sleeve 12 may also be made of metal or ceramic material and may optionally have a coating.

Furthermore, a relative movement between the outer sleeve 9 and the stirring pin 7 in the z-direction may be enabled, for example, by the spring 14 schematically illustrated in the FIGS. 1 and 3. In the embodiment of FIG. 1, there could be provided, for example, that no relative movement in the z-direction is possible between the stirring pin 7 and the tool holder 5, while a relative movement in the z-direction between the stirring pin 7 and the outer sleeve 9 remains possible through the spring 14.

FIG. 3 shows that the welding head 2 could provide a separate spring 8, 13, 14 for the stirring pin 7 as well as for the outer sleeve 9 and the reservoir sleeve 12 to allow for relative movement in the z-direction of all these elements with respect to each other and also with respect to the tool holder 5. The relative movement may, for instance, be actuated electronically, hydraulically, or purely mechanically, wherein the springs 8, 13, 14 may be used to provide a restoring force, or they may be omitted, for example, if the chosen drive does not require a restoring force. It is appreciated that it is not strictly necessary to provide for a relative movement in the z-direction of all these elements with respect to each other and also with respect to the tool holder 5, such that lowering the tool holder 5 leads in the same movement of the respective element, for which there is not provided any relative movement in the z-direction with respect to the tool holder 5.

As previously explained, the stirring pin 7 is rotatable and/or oscillatable for the production of the weld joint 31, around an axis A extending in the z-direction. The rotational movement or the oscillation movement, respectively, is typically adjustable by the friction stir welding device 1 or by a user. The rotational or oscillation speed may be selected, for example, depending on the materials of the plastic plate 3 and the metal or plastic substrate 4, wherein, however, this is not strictly necessary, as in many embodiments of the method according to the invention, the main heat is not to be generated through the rotational or oscillation movement but rather by a heating apparatus for the stirring pin 7, as will be explained in greater detail below.

The outer sleeve 9 and the reservoir sleeve 12 typically do not perform a rotational or oscillation movement around the axis A extending in the z-direction; however, this could be provided, wherein the rotational or oscillation movement of the stirring pin 7 may be selectively transmitted to the outer sleeve 9 and/or the reservoir sleeve 12 via a coupling. This may be advantageous for initiating a mixing movement within the reservoir 11.

Returning to FIG. 1, it can be seen that the outer sleeve 9 has a through-opening 15 leading to the reservoir for an external material supply. In particular, welding additives may be introduced into the reservoir 11 to impart particularly preferred properties to the weld joint 31 produced. To the end of the through-opening that is facing away from the reservoir 11, an extruder (not further depicted) may be connected, or a plastic wire can be supplied, to convey the welding additives into the reservoir 11. In this way, the welding pressure may be additionally regulated.

The through-opening 15 for the integral outer sleeve 9 illustrated in FIG. 1 may also be employed in the embodiment of FIG. 3, wherein the through-opening 15 preferably only runs through the outer sleeve 9. However, optionally, the through-opening 15 could also extend at least partially through the reservoir sleeve 12.

In FIG. 4 there is shown a particularly preferred development that is preferably usable in combination with the through-opening 15. Herein, it is to be noted that the stirring pin 7 comprises an upper section with a first diameter d1 and a lower second section with a second diameter d2, which is smaller than the first diameter d1. On the second section, there is present at least partially a conveyor screw F, meaning that it has at least one groove-shaped indentation with a gradient extending in the z-direction. This allows material to be introduced particularly efficiently into the penetration site formed by the stirring pin 7 in the plastic plate 3 or in the metal or plastic substrate 4, respectively. As depicted, the second section at the lower end is preferably not formed as a conveyor screw F, but rather has a substantially cylindrical or frustoconical shape to penetrate better into the plastic plate 3 or into the metal or plastic substrate 4, respectively.

In the embodiment shown in FIG. 4, the reservoir 11 is preferably formed by the outer sleeve 9 having a tapering step 16 located at the lower end, which has an inner diameter of substantially d2 and surrounds the second section of the stirring pin 7. Above the step 16, the outer sleeve 9 has an inner diameter of substantially d1. Thus, in this embodiment, the reservoir 11 does not lie directly on the surface of the plastic plate 3 but is rather located at a distance above it. In another, not depicted embodiment, the stirring pin could also have a step, and the outer sleeve could have a cylindrically shaped inner wall.

There is further depicted in FIG. 1 that the stirring pin 7 may comprise a heating apparatus 17 to directly heat the stirring pin 7 and bring it to a predetermined welding temperature. According to the invention, heat may therefore be introduced into the workpiece directly via the stirring pin 7. In the embodiment of FIG. 1 there is schematically illustrated that the stirring pin 7 may have two openings extending parallel to the z-axis, in which heating cartridges may be arranged that convert electrical energy into heat.

A specific embodiment of the heating apparatus 17 is illustrated in FIG. 5, wherein there are provided two sliding contacts 18, which are guided through the outer sleeve 9 and each contact a ring-shaped contact point 19 on the stirring pin 7. In other variants, the sliding contacts could also be guided above the outer sleeve 9 to the contact points 19, meaning that the outer sleeve 9 does not necessarily have to be perforated. The contact points 19 are in turn connected to one or more heating cartridges 20, which heat the stirring pin 7. With this embodiment, it is possible to transfer electrical energy into the interior of the stirring pin 7, even when it is rotating or oscillating.

FIG. 6 shows an embodiment, where an induction coil 21 is arranged around the stirring pin 7. When alternating current is applied to the induction coil 21 via lines 22, a magnetic alternating field is generated, which can heat the stirring pin 7 when it contains an inductively heatable material (i.e., electrically conductive material). In the embodiment shown, the stirring pin 7 comprises a heat conductor 23 in its interior. Since the induction coil 21 is not directly arranged within the stirring pin 7 in this embodiment, it is generally stated that the welding head 2 comprises a heating apparatus 17 for directly heating the stirring pin 7 to bring it to a predetermined welding temperature.

Furthermore, the stirring pin 7 may have a friction attachment 25 at its lower end, which faces the plastic plate 3, as seen in FIG. 5. This is particularly advantageous when the welding process is performed on a metal substrate 4, as the stirring pin 7 here may be additionally reinforced at the particularly stressed point.

Referring to FIGS. 7a, 7b, and 7c, the welding method carried out using the welding head 2 described above will be illustrated. According to FIG. 7a, the workpiece is first provided, i.e., the plastic plate 3 is placed onto the metal or plastic substrate 4. The welding head 2 is then positioned above the plastic plate 3 and moved in the direction of the plastic plate 3 until the stirring pin 7 and/or the resting surface 10 of the outer sleeve 9 rests on the plastic plate 3. At this point, the stirring pin 7 is preferably already heated by the heating apparatus 17.

According to 7b, the stirring pin 7 then penetrates into the plastic plate 3 and passes through it until the stirring pin 7 contacts the metal or plastic substrate 4 or penetrates into the metal or plastic substrate 4 to a predetermined depth. During the movement of the stirring pin 7 from the state in FIG. 7a to the state in FIG. 7b, the stirring pin 7 preferably rotates or oscillates about the axis A and/or is heated by the heating apparatus 17. In any case, the stirring pin 7 rotates or oscillates when it comes into contact with the metal or plastic substrate 4 to condition it for the welding process.

It is evident that due to the penetration of the stirring pin 7 into the state shown in FIG. 7b material is displaced from the plastic plate 3 and, optionally, also material from the metal or plastic substrate 4. This material is captured by the reservoir 11. However, since the reservoir 11 continues to maintain the material under pressure, there will be present a predetermined or adjustable welding pressure. If the welding head 2 comprises a reservoir sleeve 12, the amount of material captured in the reservoir 11 may be adjusted by moving the reservoir sleeve 12 in the z-direction. In addition, the welding pressure may be further adjusted by feeding material through the through-opening 15 into the reservoir 12.

As shown in FIG. 7c, the welding head 2 with the rotating or oscillating and optionally heated stirring pin 7 may now be moved in the welding direction S using the linear drive to create a linear weld joint 31 between the plastic plate 3 and the metal or plastic substrate 4. It is evident that behind the stirring pin 7, as viewed in the welding direction S, a weld structure 24 is being formed, meaning an elongated weld seam that connects the plastic plate 3 with the metal or plastic substrate 4. The weld structure forms the weld joint 31 after the stirring pin 7 is removed from the plastic plate 3.

FIGS. 8a and 8b show a variant of the outer sleeve 9 that is wedge-shaped. The tip of the wedge faces the workpiece and may optionally be rounded. This outer sleeve is an example of a symmetrically profiled outer sleeve 9, in contrast to the rotationally symmetrical outer sleeve 9 of FIGS. 1 and 3. In other words, the resting surface 10 of the outer sleeve 9 in FIGS. 8a and 8b has two flat sections 26 that are symmetrically arranged and positioned at an angle around the axis A. For a welding process, the two sections 26 are arranged such that the welding direction S is in parallel to the sections 26. Furthermore, an imaginary cutting line of the two sections 26 lies perpendicular to the axis A and is in parallel to the welding direction during a welding process. Such an outer sleeve 9 provides in particular for the production of fillet welds during a welding process.

FIGS. 9a and 9b show a variation of the outer sleeve 9, which is formed by two wedge-shaped pieces, offset in the z-direction, with their tips facing the workpiece and potentially rounded. This outer sleeve 9 is an example of an asymmetrically profiled outer sleeve. In other words, the resting surface 10 of this outer sleeve 9 comprises two first sections 27 and two second sections 28, each of which are flat surfaces. At the lower end, which faces the workpiece, the two first sections 27 are symmetrically arranged and angled around the axis A, while the second sections 28 are also symmetrically arranged and angled (typically at the same angle as the first sections 27) around the axis A. Although both the first sections 27 and the second sections 28 are symmetrically configured in relation to one another, the imaginary cutting line of the first sections 27 or the second sections 28, respectively, are spaced apart in the z-direction, thereby forming the two offset wedge-shaped pieces. Such an outer sleeve 9 enables in particular the production of fillet welds or other seam shapes during a welding process.

While the embodiments shown in FIGS. 8a to 9b are depicted in combination with the conveyor screw F and the internal reservoir 11, there could also be used a wedge-shaped or otherwise shaped outer sleeve 9 also in combination with a reservoir 11, as illustrated in the embodiments of FIGS. 1 and 3.

1. A friction stir welding device for producing a spot-shaped or linear weld joint between a plastic plate or a plastic moulding and a metal or plastic substrate, comprising a welding head having a rotatable or oscillatable stirring pin and an outer sleeve surrounding the stirring pin,
wherein there is provided a reservoir for receiving material displaced by the stirring pin between the outer sleeve and the stirring pin, wherein the reservoir is preferably limited by a step formed integrally with the outer sleeve or by a reservoir sleeve provided between the outer sleeve and the stirring pin,
characterised in that
the friction stir welding device further comprises a heating device for the direct heating of the stirring pin.

2. The friction stir welding device according to claim 1, wherein the heating device comprises a heating cartridge arranged in the stirring pin, which is preferably in contact with an energy source arranged outside the stirring pin via sliding contacts.

3. The friction stir welding device according to claim 1, wherein the heating device comprises an induction coil arranged around the stirring pin and a material that may be heated inductively located in or on the stirring pin.

4. The friction stir welding device according to claim 1, wherein the friction stir welding device comprises a manually operable or controlled linear feed for the linear movement of the welding head during the welding process.

5. The friction stir welding device according to claim 1, wherein the welding head, preferably the outer sleeve, has a through-opening leading to the reservoir for an external material supply or for material discharge.

6. The friction stir welding device according to claim 1, further comprising a coupling that selectively couples the stirring pin with the outer sleeve and/or the reservoir sleeve for the transmission of torque.

7. The friction stir welding device according to claim 1, wherein the stirring pin has a section facing the plastic plate or plastic moulding, at least a part of which is formed as a conveyor screw.

8. A friction stir welding method using a friction stir welding device according to claim 1, comprising the steps of:
placing the plastic plate or the plastic moulding onto the metal or plastic substrate,
inserting the stirring pin into the plastic plate or the plastic moulding until it penetrates the plastic plate and at least contacts the metal or plastic substrate, and positioning the outer sleeve on the plastic plate or on the plastic moulding,
moving the welding head using the linear drive with the rotating or oscillating stirring pin while it penetrates the plastic plate or the plastic moulding and at least contacts the metal or plastic substrate, to generate a linear weld joint.

9. The friction stir welding method according to claim 8, wherein the metal or plastic substrate is a housing having an opening and the plastic plate or the plastic moulding is a lid, comprising the steps:
placing the lid onto the opening, and
creating a closed linear weld joint around the opening to seal the opening tightly with the lid.

10. The friction stir welding method according claim 8, wherein the plastic plate and/or the plastic substrate is made of polyamide, preferably PA6 GF30, and the optionally present metal substrate is made of aluminium, preferably cast aluminium, particularly preferably cast aluminium EN AC44200.
